(19) United States
(12) Patent Application Publication
(10) Pub. No.: US 2005/0155496 A1
(43) Pub. Date: Jul. 21, 2005

(54) Roaster oven

(76) Inventor: Chien-Chang Lu, Tainan Hsien (TW)

Correspondence Address: Chien-Chang Lu, P.O. Box 90, Tainan City, 704, TW

(21) Appl. No.: 10/759,121

(22) Filed: Jan. 20, 2004

(51) Int. Cl. A47J 37/04

(52) U.S. Cl. 99/419

(57) ABSTRACT

A roaster oven has its oven body pivotally provided with two side plates and two covering plates around four sides. The side plates and the covering plates are respectively connected by position members. A plurality of spits are fitted across the two side plates for pricking food thereon, respectively having one end assembled with a motor. The oven body is bored with an elongate hole in its front lower portion for letting through a net base on which charcoal is placed, with a handle provided on the outer side of the net base. Thus, when the motor is started, the spit will be actuated to rotate to carry out roasting automatically. The net base can freely be pulled out of or pushed in the oven body, convenient to start a fire or add charcoal or put out the fire for cleaning out charcoal ashes.

### BACKGROUND OF THE INVENTION

1. Field of the Invention

This invention relates to roaster ovens, and particularly, to a roaster oven able to adjust roasting portions of food and time needed for roasting to let the food roasted evenly and thoroughly.

2. Description of the Prior Art

A conventional charcoal roaster oven 1, as shown in FIG. 1, is provided on the oven frame 10 with a tubular skewer 11 for pricking chickens or other food to be roasted and a roasting net 12 for placing roasting food thereon. Food pricked on the tubular skewer 11 and placed on the roasting net 12 is roasted over charcoal 13 paved under the oven frame 10. The tubular skewer 11 is connected with a handle 110 to be held to rotate the tubular skewer 11 for carrying out roasting. However, the oven frame 10 of the conventional charcoal roaster oven 1 is in an open condition; and therefore, flame of charcoal is usually dispersed by wind so that heat source can hardly be concentrated, resulting in waste of fuel and time and failing to roast food evenly. In addition, to add charcoal to the roaster oven 1 or clean out charcoal ashes, both the tubular skewer 11 and the roasting net 12 have to be first removed from the oven frame 10, troublesome in operating and likely to cause scald to a user.

### SUMMARY OF THE INVENTION

A first objective of the invention is to offer a roaster oven able to adjust roasting portions of food and time needed for roasting to let food roasted evenly and completely, and also able to concentrate heat source and prevent ash, dust, flies or floating impurities from sticking to the food being roasted.

A second objective of the invention is to offer a roaster oven provided with a net base able to be pulled out of or pushed in the oven body of the roaster oven, convenient to start a fire or add charcoal or put out the fire for cleaning out charcoal ashes and needless to remove the spits and the net frame from the oven body.

The feature of the invention is an oven body having its left and right side respectively and pivotally provided with a side plate, and its front and rear side respectively and pivotally provided with a covering plate, and a lower portion of the front side bored with an accommodating space, with each side plate provided with at least one vertical groove having one side bored with a plurality of engage notches; a plurality of position members respectively connecting the side plates with the covering plates; a plurality of spits movably fitted across the two side plates of the oven body; at least one motor assembled with one end of the spit and a net base movably inserted through the elongate hole in the oven body.

### BRIEF DESCRIPTION OF DRAWINGS

This invention will be better understood by referring to the accompanying drawings, wherein:

FIG. 1 is a perspective view of a conventional roaster oven;

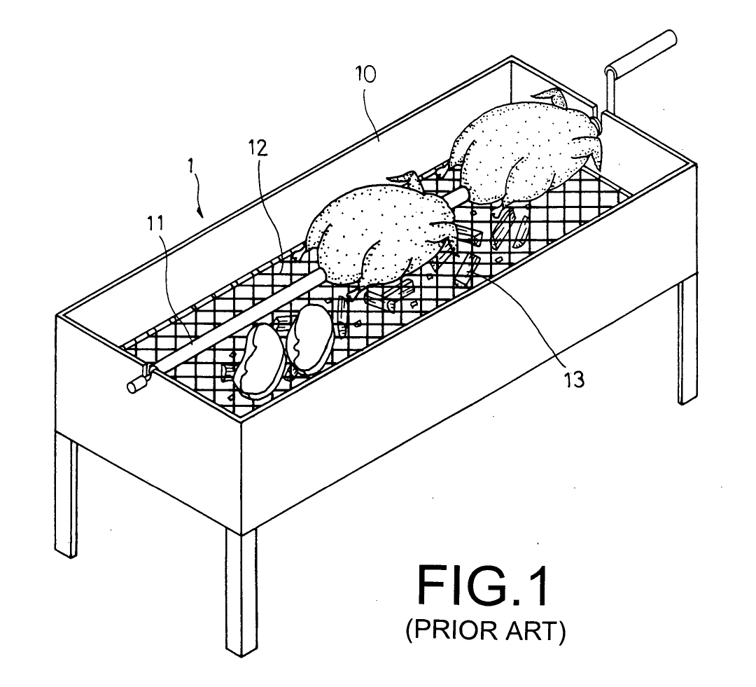

FIG. 2 is a perspective view of a roaster oven in the present invention; and,

FIG. 3 is a perspective view of the roaster oven in a used condition in the present invention.

### DETAILED DESCRIPTION OF THE PREFERRED EMBODIMENT

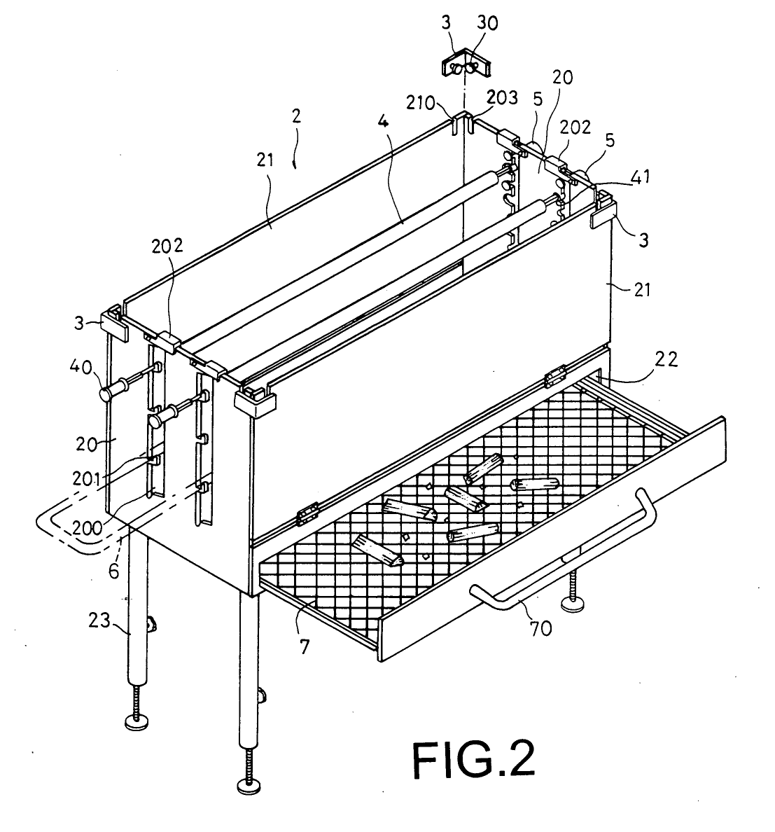

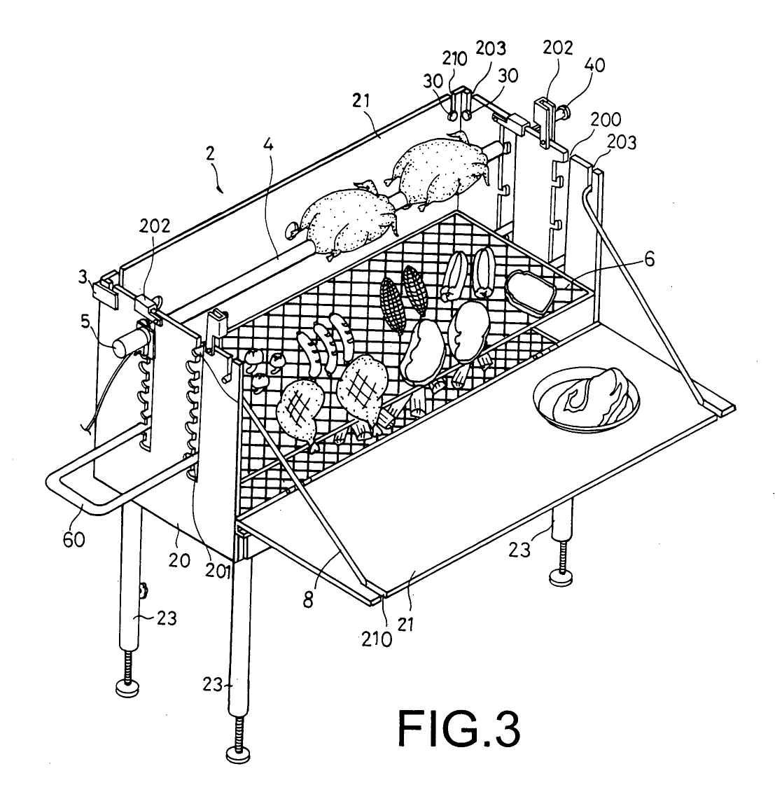

A preferred embodiment of a roaster oven in the present invention, as shown in FIGS. 2 and 3, includes an oven body 2, a plurality of position members 3, a plurality of spits 4, at least one motor 5, a net frame 6, a drawer-style net base 7 and two support members 8 as main components combined together.

The oven body 2 has a left and a right side and each of the left side and right side is pivotally provided with a side plate 20, and has a front and a rear side each of which is pivotally provided with a covering plate 21. Each side plate 20 is provided with at least one vertical groove 200 having one side bored with a plurality of continual engage notches 201. The upper end thereof is pivotally provided with a stop member 202. Further, each of two ends of an upper side of each side plate 20 has an insert groove 203, and each of two ends of an upper side of each covering plate 21 has an insert groove 210 adjacent to the insert groove 203 of a respective one of the side plate 20. There are four position members 3. Each position members 3 is * engaged with a respective insert groove 203 and a respective insert groove 210 to combine the side plates 20 with the covering plates 21 together. Furthermore, the oven body 2 has an elongate hole 22 in the lower portion of the front side, and four telescopic feet 23 provided under the bottom of the oven body 2.

The position members 3 are engaged in the insert grooves 203 and 210 to combine the side plates 20 with the covering plates 21 together when the oven body 2 is expanded for use. Each position member 3 is L-shaped, having its inner sides respectively riveted with an engage member 30 to be respectively engaged in the insert groove 203, 210 of the side plate 20 and the covering plate 21.

The spits 4 are pivotally fitted across the two side plates 20 of the oven body 2. Each end of each spit 4 has a grip 40 and the other end thereof is provided with a connect end 41 for connecting the motor 5.

The net frame 6 is movably positioned across the two side plates 20 of the oven body 2. Two opposite ends of each net frame 6 have respective lifting handles 60.

The drawer-type net base 7 is inserted in the oven body 2 through the elongate hole 22 for placing charcoal thereon. The net base 7 has a handle 70 provided on the outer side thereof.

Two opposite ends of each of the two support members 8 hook respective insert grooves insert groove 203, 210 of the side plate 20 and the covering plate 21 so as to horizontally position the covering plate 21 for placing articles thereon.

In using, as shown in FIGS. 2 and 3, firstly, charcoals are paved on the net base 7 and push the net base 7 in the accommodating space 22 of the oven body 2. Next, the net frame 6 and the spits 4 with food thereon are fitted across the two side plates 20 of the oven body 2, and then food easy to be quickly roasted, such as cut meat, ham and vegetables, is placed on the net frame 6 and after chickens or other food are pricked together by the spits 4. The connect end 41 of the spits 4 is connected with the motor 5 and the other end with the grip 40 is engaged with a proper engage notch 201 of the side plate 20 of the oven body 2.

Thus, when the motor 5 is started, the spits 4 will be actuated to rotate together with the chicken or other food pricked thereon, and by controlling the motor 5, the roasting portions of the chicken or other food and time roasting can be adjusted to attain a balanced roasting condition. For instance, a chicken belly with much flesh usually requires much time; and therefore, when the chicken belly is turned and positioned downward, the motor 5 is stopped to let the chicken belly kept in place and being roasted for a comparatively long period of time, and time needed for roasting other portions of the chicken can also be adjusted by controlling the motor 5 to actuate the spits 4 to rotate, enabling chickens or other food to be roasted completely and evenly.

In addition, during roasting, the covering plates 21 can be erected up to concentrate heat source so as to save time and fuel in roasting, and the net base 7 can be freely pulled out of or pushed in the oven body 2. Thereby, it is convenient to ignite a fire or add charcoals or put out the fire for cleaning out charcoal ashes and needless to remove the spits 4 and the net frame 6 from the oven body 2. Moreover, the covering plate 21 can be positioned horizontally by the two support members 8 respectively hooking the insert grooves 203, 210 of the side plates 20 and the covering plates 21, letting the covering plate 21 serve as a table top for placing articles thereon.

As can be understood from the above description, this invention has the following advantages.

1. It can quickly be expanded for use, convenient in handling.

2. Roasting portions of food and time needed for roasting can be adjusted by controlling the changeover switch of the motor, letting food roasted evenly and completely.

3. The telescopic feet 23 provided under the oven body 2 can be freely adjusted in height to match with different heights of users for facilitating work.

4. It can quickly be collapsed into small dimensions for storing.

5. During roasting, the covering plates 21 can be erected up to concentrate heat source for saving time of roasting.

6. The covering plates 21 can be erected up, not only able to concentrate heat source to heighten roasting efficiency, but also able to prevent car exhaust, ashes, flies or floating impurities from sticking to the chicken or other food being roasted.

7. The drawer-style net base 7 can be pulled outward to start a fire or add charcoal or put out the fire for cleaning out charcoal ashes so it is needless to remove the spits 4 and the net frame 6 from the oven body 2 for doing such work.

8. The covering plates 21 can be positioned horizontally by means of the support members 8, able to serve as a table top for placing articles thereon, such as dishes, table ware, food to be roasted, roasted food or the like.

While the preferred embodiment of the invention has been described above, it will be recognized and understood that various modifications may be made therein and the appended claims are intended to cover all such modifications that may fall within the spirit and scope of the invention.

1. A roaster oven comprising:
an oven body having a left side and a right side: each of said left side and said right side being provided with a side plate, each of a front side and a rear side of said oven body being respectively provided with a covering plate, each said side plate being provided with at least one vertical groove, each vertical groove having one side bored with a plurality of continual engage notches;
a plurality of position members respectively connecting said side plate with said covering plate together;
a plurality of spits fitted across said two side plates of said oven body; and,
at least one motor assembled with one end of each of said plurality of spits;
wherein in using said roaster oven said spit picks food together and fits across said two side plates, said motor is started to actuate said spit to rotate, said motor is able to control time needed for roasting, said covering plates is erected up to concentrate heat source so as to save time and fuel of roasting, said side plates and said covering plates is also erected up to prevent car exhaust, ashes, flies or floating impurities from sticking to food being roasted when carrying out roasting outdoors.

2-5. (canceled)

6. A roaster oven comprising:
an oven body having a left side and a right side; each of said left side and said right side being provided with a side plate, each of a front side and a rear side of said oven body being respectively provided with a covering plate, each said side plate being provided with at least one vertical groove, each vertical groove having one side bored with a plurality of continual engage notches; , said oven body bored with an elongate hole in a lower portion of the front side;
a plurality of position members respectively connecting said side plate and said covering plate together;
a plurality of spits fitted across said two side plates of said oven body;
at least one motor assembled with one end of each of said plurality of spits; and
a net base received in a accommodating space of said oven body;
a net frame being movably positioned across the two side plates of the oven body;
wherein said motor is started to actuate said spit to rotate and carry out roasting automatically, said net frame is able to be pulled outward for placing charcoal thereon and pushed in said oven body, convenient to start a fire or add charcoal or put out the fire for cleaning out charcoal ashes and safe in use.

7. The roaster oven as claimed in claim 6, wherein two opposite ends of each of the two support members hook and support the ends of said side plates and said covering plates to horizontally position said covering plates for placing articles thereon.

8. The roaster oven as claimed in claim 6, wherein said net base is provided with a handle on its outer side.
